(19) United States
(12) Patent Application Publication
(10) Pub. No.: US 2024/0198641 A1
(43) Pub. Date: Jun. 20, 2024

(54) SHRINK FILM AND PACKAGE

(71) Applicant: AMCOR FLEXIBLES NORTH AMERICA, INC., Neenah, WI (US)

(72) Inventors: Frank E. SECKAR, Oshkosh, WI (US); Jeffery C. LAWSON, Cincinnati, IA (US)

(21) Appl. No.: 18/287,280

(22) PCT Filed: Apr. 22, 2021
(86) PCT No.: PCT/US2021/028596

§ 371 Date: Oct. 17, 2023

(51) Int. Cl. B32B 27/08; B32B 7/12; B32B 27/18; B32B 27/30; B32B 27/32; B32B 27/34; B32B 27/36

(52) U.S. Cl. CPC B32B 27/08; B32B 7/12; B32B 27/18; B32B 27/306; B32B 27/308; B32B 27/32; B32B 27/34; B32B 27/36; B32B 2250/24; B32B 2307/31; B32B 2307/406; B32B 2307/414; B32B 2307/54; B32B 2307/581; B32B 2307/7244; B32B 2307/7246; B32B 2307/736; B32B 2307/7376; B32B 2307/748; B32B 2553/00

(57) ABSTRACT

A fully coextruded shrink film is disclosed. The film includes a first polar polymer layer, a bonding layer, and a sealant layer. The bonding layer includes a blend of a bonding material and a compatibilizer material. The sealant layer is a first outer layer. The bonding layer including the compatibilizer material is positioned between the first polar polymer layer and the sealant layer. The film includes a shrinkage value of greater than 10% in each of the machine direction and the transverse direction when tested according to ASTM D2732-03 using a bath temperature of 90 degrees Celsius (° C.).

### TECHNICAL FIELD

The present disclosure relates generally to a shrink film. In particular, the present disclosure relates to a recyclable shrink film, and a package including the shrink film.

### BACKGROUND

Shrink films are generally used for packaging of food products, such as meat and cheese, and non-food items. Shrink films are typically required to have shrinkage values of greater than about 10% and low oxygen transmission rate. Conventional shrink films having shrinkage values of greater than 10% are not recyclable and may contaminate recycling streams. Conventional shrink films that provide barrier properties include polyvinylidene chloride (PVDC). PVDC is generally not recyclable and may contaminate a recycling stream. Some other conventional shrink films may include different materials, such as nylon and ethylene vinyl alcohol copolymer (EVOH). Such shrink films exhibit a lower shrinkage than the shrink films that include PVDC. Further, shrink films including nylon and EVOH may not be recyclable. Non-recyclability may also be due to use of additional materials in shrink films including nylon and EVOH. In some cases, such shrink films may include polymers that are cross-linked by using various techniques, such as electron beam curing (EBC), to improve their thermal resistance, which may render such shrink films not recyclable.

### SUMMARY

A recyclable shrink film having shrinkage value of greater than 10% has been developed. Shrink films find their application in packaging of various products including food items, such as meat and cheese, and non-food items.

In an embodiment of the present disclosure, a fully coextruded shrink film is disclosed. The film includes a first polar polymer layer, a bonding layer, and a sealant layer. The bonding layer includes a blend of a bonding material and a compatibilizer material. The sealant layer is a first outer layer of the film. The bonding layer including the compatibilizer material is positioned between the first polar polymer layer and the sealant layer. The film includes a shrinkage value of greater than 10% in each of the machine direction and the transverse direction when tested according to ASTM D2732-03 using a bath temperature of 90 degrees Celsius (° C.).

In some embodiments, the first polar polymer layer includes one or more of an ethylene vinyl alcohol (EVOH) copolymer, a polyamide, and a polyester.

In some embodiments, the first polar polymer is a second outer layer of the film.

In some embodiments, the shrink film further includes a second polar polymer layer positioned between the first polar polymer layer and the sealant layer.

In some embodiments, the bonding layer includes the compatibilizer material in an amount from 5% to 35% by weight of the first polar polymer layer.

In some embodiments, the bonding layer includes the compatibilizer material in an amount from 5% to 35% by weight of the second polar polymer layer.

In some embodiments, the film further includes an intermediate layer including the compatibilizer material.

In some embodiments, the compatibilizer material includes one or more of a low molecular weight anhydride and a carboxylic acid functionalized polyethylene.

In some embodiments, the bonding material includes a polyethylene polymer, an ethylene acrylic acid (EAA) copolymer, a two-component reactive adhesive, or combinations thereof.

In some embodiments, the film is recyclable.

In some embodiments, the film includes an average interlayer bond strength of greater than about 8 grams per millimeter (g/mm).

In an embodiment, a package including the film of the previous embodiment is disclosed.

In another embodiment of the present disclosure, a fully coextruded shrink film is disclosed. The film includes a first polar polymer layer, a first bonding layer, a second polar polymer layer, a second bonding layer, and a sealant layer. The first polar polymer layer includes a polyamide. The first bonding layer includes a compatibilizer material and a bonding material. The second polar polymer layer includes an ethylene vinyl alcohol (EVOH) copolymer. The second bonding layer includes the compatibilizer material and the bonding material. The sealant layer is a first outer layer of the film. The first polar polymer layer is a second outer layer of the film. The first bonding layer is positioned between the first polar polymer layer and the second polar polymer layer. The second bonding layer is positioned between the second polar polymer layer and the sealant layer. The film includes a shrinkage value of greater than 10% in each of the machine direction and the transverse direction when tested according to ASTM D2732-03 using a bath temperature of 90 degrees Celsius (° C.).

In some embodiments, the first bonding layer includes the compatibilizer material in an amount from 5% to 35% by weight of the polyamide in the first polar polymer layer.

In some embodiments, the second bonding layer includes the compatibilizer material in an amount from 5% to 35% by weight of the EVOH copolymer in the second polar polymer layer.

In an embodiment, a package including the film of the previous embodiment is disclosed.

There are several other aspects of the present subject matter which may be embodied separately or together. These aspects may be employed alone or in combination with other aspects of the subject matter described herein, and the description of these aspects together is not intended to preclude the use of these aspects separately or the claiming of such aspects separately or in different combinations.

### BRIEF DESCRIPTION OF THE DRAWINGS

The disclosure may be more completely understood in consideration of the following detailed description of various embodiments of the disclosure in connection with the accompanying drawings, in which:

FIG. 1 illustrates a cross-sectional view of a shrink film, in accordance with an embodiment of the present disclosure;

FIG. 2 illustrates a cross-sectional view of another shrink film, in accordance with an embodiment of the present disclosure;

FIG. 3 illustrates a cross-sectional view of another shrink film, in accordance with an embodiment of the present disclosure;

FIG. 4 illustrates a cross-sectional view of another shrink film, in accordance with an embodiment of the present disclosure;

FIG. 5 illustrates a cross-sectional view of another shrink film, in accordance with an embodiment of the present disclosure; and

FIG. 6 illustrates a perspective view of a package including the packaging film, in accordance with an embodiment of the present disclosure.

The figures are not necessarily to scale. Like numbers used in the figures refer to like components. It will be understood, however, that the use of a number to refer to a component in a given figure is not intended to limit the component in another figure labeled with the same number.

The drawings show some but not all embodiments. The elements depicted in the drawings are illustrative and not necessarily to scale, and the same (or similar) reference numbers denote the same (or similar) features throughout the drawings.

### DETAILED DESCRIPTION

The present disclosure relates to a fully coextruded shrink film with shrinkage values in both machine and transverse directions. The shrink film may further be recyclable. The shrink film includes a first polar polymer layer, a bonding layer, and a sealant layer. The bonding layer includes a blend of a bonding material and a compatibilizer material. The sealant layer is a first outer layer of the film. The bonding layer including the compatibilizer material is positioned between the first polar polymer layer and the sealant layer. The film includes a shrinkage value of greater than 10% in each of the machine direction and the transverse direction when tested according to ASTM D2732-03 using a bath temperature of 90 degrees Celsius (° C.).

The present disclosure further provides another fully extruded shrink film. The film includes a first polar polymer layer including a polyamide, a first bonding layer including a compatibilizer material and a bonding material, a second polar polymer layer including an ethylene vinyl alcohol (EVOH) copolymer, a second bonding layer including the compatibilizer material and the bonding material, and a sealant layer. The sealant layer is a first outer layer of the film. The first polar polymer layer is a second outer layer of the film. The first bonding layer is positioned between the first polar polymer layer and the second polar polymer layer. The second bonding layer is positioned between the second polar polymer layer and the sealant layer. The film includes a shrinkage value of greater than 10% in each of the machine direction and the transverse direction when tested according to ASTM D2732-03 using a bath temperature of 90° C.

The present disclosure further provides a package including the shrink film.

The shrink films according to the present disclosure include shrinkage values of greater than 10% in each of the machine direction and the transverse direction when tested according to ASTM D2732-03. Further, the compatibilizer material in the first and second bonding layers may improve recyclability of the shrink film. Thus, the shrink film of the present disclosure may not contaminate the recycling streams and provides recyclate that may be appropriate according to post-consumer recycling (PCR) guidelines, for example, the Association of Plastic Recyclers (APR) protocol.

Further, the shrink film may have an improved interlayer bond strength and an improved puncture resistance.

Moreover, since the sealant layer is the first outer layer of the film and the first polar polymer is the second outer layer of the film, the shrink film may not require polymer cross-linking techniques, such as EBC, in order to provide thermal resistance. This may further improve the recyclability of the shrink film. Further, the shrink film may not require any additional manufacturing processes. In addition, the shrink film may be manufactured using existing co-extrusion equipment and technologies.

As used in the present disclosure, the term “film” is a material with a very high ratio of length or width to thickness. A film has two major surfaces defined by a length and width. Films can be flexible and can be used for a wide variety of applications, including flexible packaging. Films may also be of thickness and/or material composition such that they are semi-rigid or rigid. Films described in the present disclosure are composed of various polymeric materials but may also contain other materials, such as metals or papers. Films may be described as monolayer or multilayer.

As used in the present disclosure, the term “layer” refers to a thickness of material within a film that has a relatively consistent formula. Layers may be of any type of material including polymeric, cellulosic, and metallic, or a blend thereof. A given polymeric layer may consist of a single polymer-type or a blend of polymers and may be accompanied by additives. A given layer may be combined or connected to other layers to form films. A layer may be either partially or fully continuous as compared to adjacent layers or the film. A given layer may be partially or fully coextensive with adjacent layers. A layer may contain sub-layers.

As used in the present disclosure, the term “outer layer” refers to a layer of a film structure that includes a major exterior surface of the film. An outer layer may consist of a single layer or may be multi-layered. There may be one outer layer or two outer layers in a film. For example, a first outer layer may include a first major exterior surface of the film, while a second outer layer may include a second major exterior surface of the film.

As used in the present disclosure, the term “internal layer” refers to a layer of a film structure that does not reside on either major exterior surface of the film. An internal layer may consist of a single layer or may be multi-layered. There may be one or more internal layers in a film.

As used in the present disclosure, the term “package” refers to any product or combination of products used to wholly or partially surround a product. A package may take many various forms. For example, the term “package” may include bags that wholly surround a product (or products) to be packaged; the term “package” may also include films that partially surround a product (or products) to be packaged and, when used in conjunction with another material (such as a tray), wholly surround a product (or products).

As used in the present disclosure, the term “oriented” refers to a monolayer or multilayer film, sheet, or web which has been elongated in a machine direction and/or a transverse direction. Such elongation is accomplished by procedures known to a person of ordinary skill in the art. Non-limiting examples of such procedures include the single bubble blown film extrusion process and the slot case sheet extrusion process with subsequent stretching, for example, by tentering, to provide orientation. Another example of such procedure is the trapped bubble or double bubble process. (See, for example, U.S. Pat. Nos. 3,546,044 and 6,511,688, each of which is incorporated in its entirety in this application by this reference.) In the trapped bubble or double bubble process, an extruded primary tube leaving a tubular extrusion die is cooled, collapsed, and then oriented by reheating, reinflating to form a secondary bubble and re-cooling. Transverse direction orientation may be accomplished by inflation, radially expanding the heated film tube. Machine direction orientation may be accomplished by the use of nip rolls rotating at different speeds, pulling or drawing the film tube in the machine direction. The combination of elongation at elevated temperature followed by cooling causes an alignment of the polymer chains to a more parallel configuration, thereby improving the mechanical properties of the film, sheet, web, package or otherwise.

As used in the present disclosure, the term “directly adjacent” identifies two layers of a film that share an interface, i.e., two layers of the film that contact each other such that a surface forms a common boundary between the two layers.

As used in the present disclosure, the terms “bonding layer”, “adhesive layer”, or “tie layer”, refer to a layer or material placed in or on one or more layers to promote the adhesion of that layer to another surface. Preferably, adhesive layers are positioned between two layers of a multilayer film to maintain the two layers in position relative to each other and prevent undesirable delamination. Unless otherwise indicated, an adhesive layer can have any suitable composition that provides a desired level of adhesion with the one or more surfaces in contact with the adhesive layer material. Optionally, an adhesive layer placed between a first layer and a second layer in a multilayer film may include components of both the first layer and the second layer to promote simultaneous adhesion of the adhesive layer to both the first layer and the second layer to opposite sides of the adhesive layer.

As used in the present disclosure, the term “polyolefin” refers to polyethylene homopolymers, polyethylene copolymers, polypropylene homopolymers, or polypropylene copolymers.

As used in the present disclosure, the term “polyethylene” refers to polymers that include an ethylene linkage. Polyethylenes may be a homopolymer, copolymer or interpolymer. Polyethylene copolymers or interpolymers may include other types of polymers (i.e., non-polyethylene polymers). Polyethylenes may have functional groups incorporated by grafting or other means. Polyethylenes include, but are not limited to, low-density polyethylene (LDPE), linear low density polyethylene (LLDPE), medium-density polyethylene (MDPE), linear medium-density polyethylene (LMDPE), ultra-low density polyethylene (ULDPE), high-density polyethylene (HDPE), cyclic-olefin copolymers (COC), ethylene vinyl acetate copolymers (EVA), ethylene acrylic acid copolymers (EAA), ethylene methacrylic acid copolymers (EMAA), neutralized ethylene copolymers such as ionomer, and maleic anhydride grafted polyethylene (MAHgPE).

As used in the present disclosure, the terms “polyamide” or “PA” or “nylon” refer to a homopolymer or copolymer having an amide linkage between monomer units and formed by any method known in the art. The amide linkage may be represented by the general formula: [C(O)—R—C(O)—NH—R′—NH] n where R and R′ are the same or different alkyl (or aryl) group. Nylon polymers may be high-temperature, low-temperature, or amorphous, as described in, for example, International Publication Number WO 2006/063283. Examples of nylon polymers include, but are not limited to, nylon 6 (polycaprolactam), nylon 11 (polyundecanolactam), nylon 12 (polyauryllactam), nylon 4,2 (polytetramethylene ethylenediamide), nylon 4,6 (polytetramethylene adipamide), nylon 6,6 (polyhexamethylene adipamide), nylon 6,9 (polyhexamethylene azelamide), nylon 6,10 (polyhexamethylene sebacamide), nylon 6,12 (polyhexamethylene dodecanediamide), nylon 7,7 (polyheptamethylene pimelamide), nylon 8,8 (polyoctamethylene suberamide), nylon 9,9 (polynonamethylene azelamide), nylon 10,9 (polydecamethylene azelamide), and nylon 12,12 (polydodecamethylene dodecanediamide). Examples of nylon copolymers include, but are not limited to, nylon 6,6/6 copolymer (polyhexamethylene adipamide/caprolactam copolymer), nylon 6,6/9 copolymer (polyhexamethylene adipamide/azelamide copolymer), nylon 6/6,6 copolymer (polycaprolactam/hexamethylene adipamide copolymer), nylon 6,2/6,2 copolymer (polyhexamethylene ethylenediamide/hexamethylene ethylenediamide copolymer), and nylon 6,6/6,9/6 copolymer (polyhexamethylene adipamide/hexamethylene azelamide/caprolactam copolymer). Examples of aromatic nylon polymers (also sometimes referred to as “amorphous polyamide” or “amorphous nylon”) include, but are not limited to, nylon 4,1, nylon 6,1, nylon 6,6/61 copolymer, nylon 6,6/6T copolymer, nylon MXD6 (poly-m-xylylene adipamide), poly-p-xylylene adipamide, nylon 61/6T copolymer, nylon 6T/61 copolymer, nylon MXDI, nylon 67MXDT/1 copolymer, nylon 6T (polyhexamethylene terephthalamide), nylon 12T (polydodecamethylene terephthalamide), nylon 66T, and nylon 6-3-T (poly(trimethyl hexamethylene terephthalamide).

As used in the present disclosure, the term “copolymer” refers to a polymer product obtained by the polymerization reaction or copolymerization of at least two monomer species. Copolymers may also be referred to as bipolymers. The term “copolymer” is also inclusive of the polymerization reaction of three, four, or more monomer species having reaction products referred to terpolymers, quaterpolymers, etc. As used in the present disclosure, the term “polar polymer” refers to a polymer formed from at least one monomer that comprises at least one heteroatom, such as oxygen (O), nitrogen (N), phosphorus (P) or sulfur (S). Non-limiting examples of polar polymers that are typically used in packaging applications are polyester, polyamide and ethylene vinyl alcohol copolymers. A polar layer may contain more than one polar polymer. In addition to the polar polymer, a polar layer may contain other materials such as other polymers or additives such as slip. Preferably, the polar layer is made of at least 50% polar polymer, or more preferably more than 70%, more than 80%, more than 90% or more than 95% polar polymer.

As used in the present disclosure, the term “thermoplastic” refers to a material that softens when exposed to heat and which substantially returns to a non-softened condition when cooled to room temperature.

As used in the present disclosure, the terms “coextruded” or “coextrusion” refer to the process of extruding two or more polymer materials through a single die with two or more orifices arranged so that the extrudates merge and weld together into a laminar structure before chilling, i.e., quenching. The films according to the present disclosure may be fabricated by any coextrusion method known to a person of ordinary skill in the art which may include, but is not limited to, blown film coextrusion, slot cast coextrusion, and extrusion coating.

As used in the present disclosure, the term “gloss” refers to the shiny appearance of a material. It is a measure of the light reflected by the surface of a material and is measured at a specific angle of reflection (20, 45, 60, 75, or 85 degrees) against a specific backing. Gloss may be determined in accordance with ASTM D2457-90 (“Standard Test Method for Specular Gloss of Plastic Films and Solid Plastics”). Gloss values are reported in Gloss Units. A high gloss value generally indicates a material that is shinier than a material having a low gloss value.

As used in the present disclosure, the term “Shrinkage Value” refers to values obtained by measuring unrestrained (or free) shrink of a ten-centimeter square sample immersed in water at an indicated temperature for about five seconds. Generally, the indicated temperature is about 90° C. In some cases, the indicated temperature may be any temperature between about 85° C. and 90° C. In such a method, four test specimens are cut from a given sample of the film to be tested. The specimens are cut into squares of ten-centimeter length in the machine direction by ten-centimeter length in the transverse direction. Each specimen is completely immersed and unrestrained for five seconds in a water bath at the indicated temperature. The specimen is then removed from the bath and the distance between the ends of the shrunken specimen is measured for both the machine and transverse directions. The difference in the measured distance for the shrunken specimen and the original ten-centimeter side is calculated as a percentage change to obtain the percent of shrinkage for the specimen in the machine direction and the transverse direction. Shrinkage Value may be determined in accordance with ASTM D2732-03 (“Standard Test Method for Unrestrained Linear Thermal Shrinkage of Plastic Film and Sheeting”).

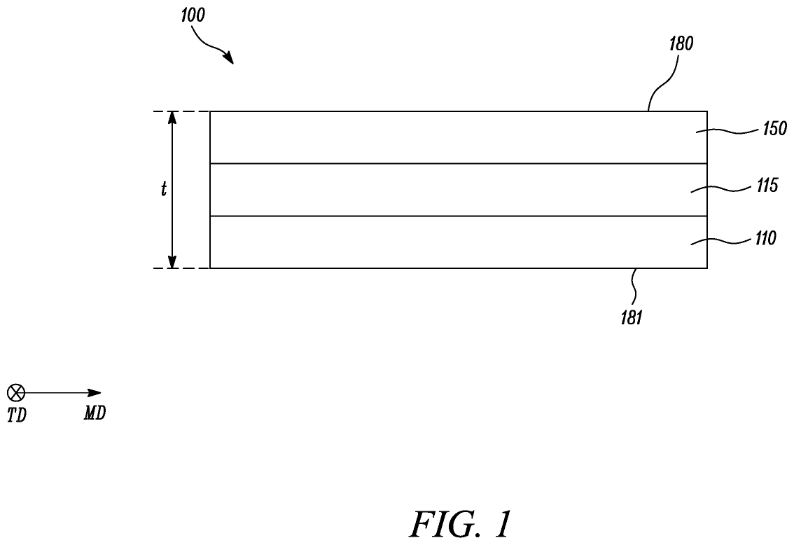

FIG. 1 shows a cross-sectional view of a fully coextruded shrink film 100, in accordance with an embodiment of the present disclosure. Shrink film 100 may be interchangeably referred to as “film 100”.

Film 100 includes a first polar polymer layer 110, a bonding layer 115, and a sealant layer 150. Film 100 is fully coextruded. In other words, first polar polymer layer 110, sealant layer 150 and bonding layer 115 are coextruded to each other. In some embodiments, film 100 is a coextruded blown film. Film 100 includes a thickness “t”.

In some embodiments, film 100 is oriented. In some embodiments, film 100 may be oriented biaxially. In some embodiments, film 100 may be oriented along a machine direction. In some other embodiments, film 100 may be oriented along a transverse direction. The machine direction may be a general direction along which film 100 travels during a stretching process, such as a machine-direction orientation process. The transverse direction may be a second axis within a plane of film 100 and may be orthogonal to the machine direction. Film 100 may be manufactured using existing co-extrusion equipment and technologies. For example, as shown in FIG. 1, a machine direction MD is along the plane of film 100. A transverse direction TD is within the plane of film 100 and orthogonal to machine direction MD.

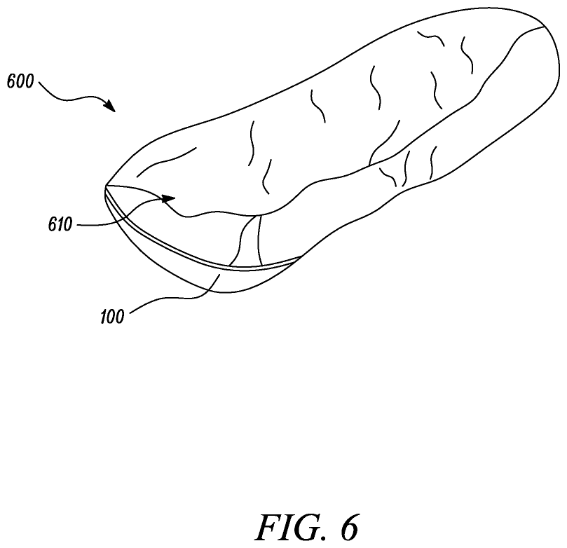

Sealant layer 150 is a first outer layer of film 100. In other words, sealant layer 150 may include a first major surface 180 of film 100. In some embodiments, first major surface 180 of film 100 may be exposed to a product (e.g., a product 610 shown in FIG. 6), when film 100 is used in a package 600 (shown in FIG. 6). In other words, sealant layer 150 may be exposed to the product, when film 100 is used in package 600 (shown in FIG. 6).

In some embodiments, sealant layer 150 may include a thermoplastic material. In some embodiments, sealant layer 150 may include polyesters, polyolefins, and/or polystyrenes. Exemplary polyolefins may include polyethylene (PE), polypropylene (PP), and polyethylene copolymers such as ethylene vinyl acetate (EVA) copolymer.

In some embodiments, first polar polymer layer 110 is a second outer layer of film 100. In other words, first polar polymer layer 110 may include a second major surface 181 of film 100. In some embodiments, first polar polymer layer 110 may be exposed to an external environment, when film 100 is used in package 600 (shown in FIG. 6). In some embodiments, first polar polymer layer 110 including second major surface 181 of film 100 may provide an improved thermal resistance to film 100. Therefore, film 100 may not require polymer cross-linking techniques, such as EBC, in order to provide thermal resistance. This may improve the recyclability of film 100. Further, film 100 may not require any additional manufacturing processes, such as cross-linking techniques

In some embodiments, first polar polymer layer 110 includes one or more of an ethylene vinyl alcohol (EVOH) copolymer, a polyamide, and a polyester. In some embodiments, the polyamide may be selected from compositions approved as safe for producing products intended for use in processing, handling and packaging of food. In some embodiments, the polyamide may include blends, such as nylon resins. In some embodiments, the nylon resins approved by the Food and Drug Administration are provided at 21 CFR § 177.1500 (“Nylon resins”), which is incorporated herein by reference. In some embodiments, the nylon resins may include nylon 66, nylon 610, nylon 66/610, nylon 6/66, nylon 11, nylon 6, nylon 66T, nylon 612, nylon 12, nylon 6/12, nylon 6/69, nylon 46, nylon PA 6-3-T, nylon MXD-6, nylon 12T, nylon 6I/6T, and amorphous nylon.

In some embodiments, first polar polymer layer 110 may provide a barrier to oxygen. In some embodiments, first polar polymer layer 110 may provide a barrier to moisture.

In some embodiments, first polar polymer layer 110 may include a monolayer, or may include two or more layers (not shown). Each of the two or more layers may include a similar material or may include different materials. Further, each of the two or more layers may have uniform or different thicknesses such that the two or more layers together include a thickness of first polar polymer layer 110.

Bonding layer 115 is positioned between first polar polymer layer 110 and sealant layer 150. Bonding layer 115 includes a blend of a bonding material and a compatibilizer material. The compatibilizer material is able to assist in the incorporation of polar materials into a reprocessing or recycling stream of non-polar polymers. The compatibilizer generally increases the stability of the dispersed polar material by providing sites that allow the two materials (polar and non-polar) to interact, increasing miscibility. Use of a compatibilizer in a blend of polar and non-polar materials generally creates a more homogeneous blend, avoiding gels and other issues that cause visual or mechanical property quality issues.

In some embodiments, the bonding material includes a polyethylene polymer, an ethylene acrylic acid (EAA) copolymer, a two-component reactive adhesive, or combinations thereof. In some embodiments, the compatibilizer material includes one or more of a low molecular weight anhydride and a carboxylic acid functionalized polyethylene. An example of a compatibilizer that can be used in the compatibilizer layer is Retain™ 3000, available from The Dow Chemical Company. The details of this material and the use of it as a compatibilizer for polar materials is outlined in patent document WO16109023, Parkinson et al. (i.e. '023), which is incorporated herein by reference. However, the films disclosed in '023, do not include any form of oriented films, thus lacking in dimensional stability and stiffness required for many high-performance packaging applications.

In some embodiments, first polar polymer layer 110 may include a polyamide. In such embodiments, bonding layer 115 includes the compatibilizer material in an amount from about 5% to about 35% by weight of first polar polymer layer 110. In some embodiments, the compatibilizer material may be included in higher quantities to ensure first polar polymer layer 110 is recyclable. In some examples, bonding layer 115 may include the compatibilizer material in an amount of 25% by weight of first polar polymer layer 110. In other words, a ratio of weights of the compatibilizer material to first polar polymer layer 110 may be 1:4. For example, bonding layer 115 may include the compatibilizer material in an amount of at least 30%, at least 40%, or at least 50% by weight of first polar polymer layer 110. In some embodiments, the bonding layer 115 may include the compatibilizer material in an amount from 5%, 10%, 15%, 20%, 25%, 30%, or 35% by weight of the first polar polymer layer 110.

In some embodiments, first polar polymer layer 110 may include an EVOH copolymer. In such embodiments, bonding layer 115 includes the compatibilizer material in an amount from about 5% to about 35% by weight of first polar polymer layer 110. In some embodiments, the compatibilizer material may be included in higher quantities to ensure first polar polymer layer 110 is recyclable. In some examples, bonding layer 115 may include the compatibilizer material in an amount of 33% by weight of first polar polymer layer 110. In other words, a ratio of weights of the compatibilizer material to first polar polymer layer 110 may be 1:3. For example, bonding layer 115 may include the compatibilizer material in an amount of at least 35%, at least 40%, at least 50%, or at least 60% by weight of first polar polymer layer 110. In some embodiments, the bonding layer 115 may include the compatibilizer material in an amount from 5%, 10%, 15%, 20%, 25%, 30%, or 35% by weight of the first polar polymer layer 110.

In some embodiments, bonding layer 115 may include the compatibilizer material in the amount from about 5% to about 35% by weight of polyamide in film 100. In some embodiments, bonding layer 115 may include the compatibilizer material in the amount from about 5% to about 35% by weight of EVOH copolymer in film 100. In some embodiments, bonding layer 115 may include the compatibilizer material in the amount from about 5% to about 35% by weight of polyamide in film 100, and from about 5% to about 35% by weight of EVOH copolymer in film 100.

In some embodiments, film 100 is recyclable. Thus, film 100 may not contaminate recycling streams and provide a recyclate of quality that may not contaminate recycling streams. Specifically, the compatibilizer material in bonding layer 115 may allow film 100 including first polar polymer layer 110 to be recyclable in the recycling streams, for example, a polyethylene recycling stream. In other words, the compatibilizer material in bonding layer 115 may improve recyclability of film 100.

Film 100 includes a shrinkage value of greater than 10% in each of the machine direction and the transverse direction when tested according to ASTM D2732-03 using a bath temperature of 90° C. In some embodiments, film 100 may include a shrinkage value greater than about 20%, greater than about 30%, greater than about 40%, or greater than about 50%, in each of the machine direction and the transverse direction when tested according to ASTM D2732-03 using the bath temperature of 90° C.

In some embodiments, film 100 includes an average interlayer bond strength of greater than about 8 grams per millimeter (g/mm) when tested according to ASTM F904-98 (90 degree supported tail). Specifically, film 100 includes the average interlayer bond strength of greater than about 8 g/mm after orientation.

In some embodiments, film 100 includes a puncture resistance that depends on the thickness “t” of film 100. In some embodiments, thickness “t” of film 100 is about 2 mil (about 50 microns). In such embodiments, film 100 includes the puncture resistance of up to a load of about 14 kilograms (kg), when tested using an Instron Dart Drop 0.25″ probe to sealant when tested according to ASTM D7192-10.

Therefore, film 100 may have an improved interlayer bond strength and an improved puncture resistance. In some embodiments, the average interlayer bond strength of film 100 may be greater than 10 g/mm, greater than 12 g/mm, greater than 15 g/mm, or greater than 20 g/mm.

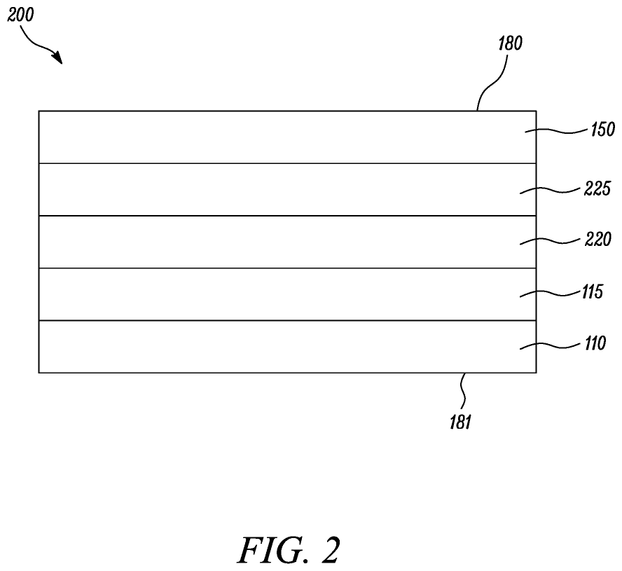

FIG. 2 shows a cross-sectional view of a fully coextruded shrink film 200, in accordance with another embodiment of the present disclosure. Shrink film 200 may be interchangeably referred to as “film 200”. Film 200 is substantially similar to film 100 illustrated in FIG. 1. Common components between film 100 and film 200 are illustrated by the same reference numerals. However, film 200 further includes a second polar polymer layer 220 positioned between first polar polymer layer 110 and sealant layer 150.

In some embodiments, film 200 further includes an intermediate layer 225 including the compatibilizer material. Film 200 is fully coextruded. In other words, first polar polymer layer 110, second polar polymer layer 220, sealant layer 150, bonding layer 115, and intermediate layer 225 are fully coextruded to each other. In some embodiments, film 200 is a coextruded blown film.

In some embodiments, film 200 is oriented. In some embodiments, film 200 may be oriented biaxially. In some embodiments, film 200 may be oriented along the machine direction. In some other embodiments, film 200 may be oriented along the transverse direction.

In some embodiments, second polar polymer layer 220 may be substantially similar to first polar polymer layer 110. In some embodiments, second polar polymer layer 220 includes one or more of an EVOH copolymer, a polyamide, and a polyester. In some embodiments, second polar polymer layer 220 may provide a barrier to oxygen. In some embodiments, second polar polymer layer 220 may provide a barrier to moisture. In some embodiments, second polar polymer layer 220 may include high-density polyethylene (HDPE).

In some embodiments, second polar polymer layer 220 may include a monolayer, or may include two or more layers (not shown). Each of the two or more layers may include a similar material or may include different materials. Further, each of the two or more layers may have uniform or different thicknesses such that the two or more layers together include a thickness of second polar polymer layer 220.

In some embodiments, intermediate layer 225 may be positioned between first polar polymer layer 110 and sealant layer 150. In the illustrated embodiment of FIG. 2, intermediate layer 225 is disposed adjacent to second polar polymer layer 220. Specifically, intermediate layer 225 is positioned between sealant layer 150 and second polar polymer layer 220. However, in some other embodiments, intermediate layer 225 may not be disposed adjacent to second polar polymer layer 220.

In some embodiments, intermediate layer 225 may include a blend including a compatibilizer material, and at least one of polyolefins and polyamide blends selected from a group including nylon resins. In some embodiments, intermediate layer 225 may include a blend including polyethylene and a compatibilizer material. Polyethylene may include ultra-low-density polyethylene (ULDPE), low density polyethylene (LDPE), linear low-density polyethylene (LLDPE), medium density polyethylene (MDPE), linear medium density polyethylene (LMDPE), high density polyethylene (HDPE), and combinations thereof.

In some embodiments, intermediate layer 225 may be included to provide improved mechanical properties to film 200. In some embodiments, intermediate layer 225 may be substantially similar to bonding layer 115.

In some embodiments, intermediate layer 225 may include a monolayer, or may include two or more layers (not shown). Each of the two or more layers may include a similar material or may include different materials. Further, each of the two or more layers may have uniform or different thicknesses such that the two or more layers together include a thickness of intermediate layer 225.

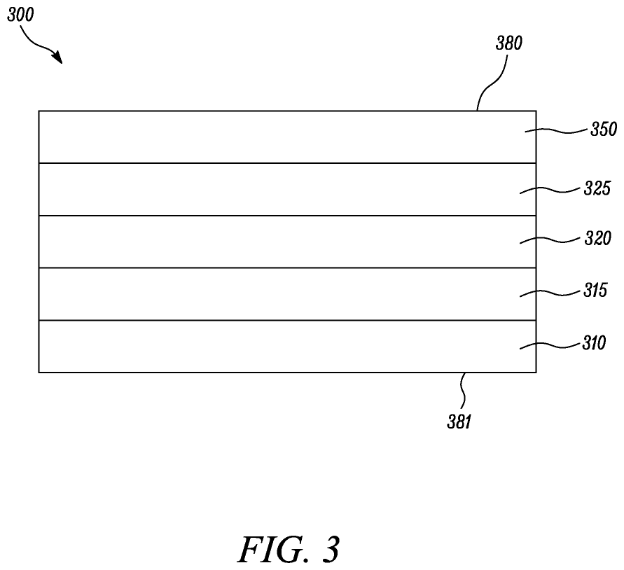

FIG. 3 shows a cross-sectional view of a fully coextruded shrink film 300, in accordance with an embodiment of the present disclosure. Shrink film 300 is interchangeably referred to as “film 300”.

Film 300 includes a first polar polymer layer 310, a first bonding layer 315, a second polar polymer layer 320, a second bonding layer 325, and a sealant layer 350. Film 300 is fully coextruded. In other words, first polar polymer layer 310, first bonding layer 315, second polar polymer layer 320, second bonding layer 325, and sealant layer 350 are coextruded to each other. In some embodiments, film 300 is a coextruded blown film.

In some embodiments, film 300 is oriented. In some embodiments, film 300 may be oriented biaxially. In some embodiments, film 300 may be oriented along the machine direction. In some other embodiments, film 300 may be oriented along the transverse direction. Film 300 may be manufactured using existing co-extrusion equipment and technologies.

Sealant layer 350 is a first outer layer of film 300. In other words, sealant layer 350 may include a first major surface 380 of film 300. In some embodiments, first major surface 380 of film 300 may be exposed to a product (e.g., product 610 shown in FIG. 6), when film 300 is used in package 600 (shown in FIG. 6). In other words, sealant layer 350 may be exposed to the product, when film 300 is used in package 600 (shown in FIG. 6). In some embodiments, sealant layer 350 is substantially similar to sealant layer 150 (shown in FIG. 1).

First polar polymer layer 310 includes a polyamide. In some embodiments, first polar polymer layer 310 is a second outer layer of film 300. In other words, first polar polymer layer 310 may include a second major surface 381 of film 300. In some embodiments, first polar polymer layer 310 may be exposed to the external environment, when film 300 is used in package 600 (shown in FIG. 6). In some embodiments, first polar polymer layer 310 including second major surface 381 of film 300 may provide an improved thermal resistance to film 300. Therefore, film 300 may not require polymer cross-linking techniques, such as EBC, in order to provide thermal resistance. This may improve the recyclability of film 300. Further, film 300 may not require any additional manufacturing processes.

First bonding layer 315 includes the compatibilizer material and the bonding material. First bonding layer 315 is positioned between first polar polymer layer 310 and second polar polymer layer 320. In some embodiments, first bonding layer 315 includes the compatibilizer material in an amount from about 5% to about 35% by weight of the polyamide in first polar polymer layer 310. In some examples, first bonding layer 315 includes the compatibilizer material in an amount of 25% by weight of the polyamide in first polar polymer layer 310. In other words, a ratio of weights of the compatibilizer material in first bonding layer 315 to the polyamide in first polar polymer layer 310 may be about 1:4.

Second polar polymer layer 320 includes an EVOH copolymer. In some embodiments, second polar polymer layer 320 may provide a barrier to oxygen.

Second bonding layer 325 includes the compatibilizer material and the bonding material. Second bonding layer 325 is positioned between second polar polymer layer 320 and sealant layer 350. In some embodiments, second bonding layer 325 includes the compatibilizer material in an amount from about 5% to about 35% by weight of the EVOH copolymer in second polar polymer layer 320. In some examples, second bonding layer 325 includes the compatibilizer material in an amount of 33% by weight of the EVOH copolymer in second polar polymer layer 320. In other words, a ratio of weights of the compatibilizer material to the EVOH copolymer in second polar polymer layer 320 may be about 1:3.

In some embodiments, film 300 may include the compatibilizer material in the amount from about 5% to about 35% by weight of polyamide in film 300. In such embodiments, the compatibilizer material may be included in at least one of first and second bonding layers 315, 325.

In some embodiments, film 300 may include the compatibilizer material in the amount from about 5% to about 35% by weight of EVOH copolymer in film 300. In such embodiments, the compatibilizer material may be included in at least one of first and second bonding layers 315, 325.

In some embodiments, film 300 may include the compatibilizer material in the amount from about 5% to about 35% by weight of polyamide in film 300, and from about 5% to about 35% by weight of EVOH copolymer in film 300. In such embodiments, the compatibilizer material may be included in at least one of first and second bonding layers 315, 325.

In some embodiments, film 300 is recyclable. Thus, film 300 may not contaminate recycling streams and provide a recyclate of quality that may not contaminate recycling streams. Specifically, the compatibilizer material in first and second bonding layers 315, 325 may allow film 300 to be recyclable in the recycling streams, for example, the polyethylene recycling stream. In other words, the compatibilizer material in first and second bonding layers 315, 325 may improve recyclability of film 300.

Film 300 includes a shrinkage value of greater than 10% in each of the machine direction and the transverse direction when tested according to ASTM D2732-03 using a bath temperature of 90° C. In some embodiments, film 300 may include a shrinkage value greater than about 20%, greater than about 30%, greater than about 40%, or greater than about 50%, in each of the machine direction and the transverse direction when tested according to ASTM D2732-03 using the bath temperature of 90° C. Further, film 300 may have an improved interlayer bond strength and an improved puncture resistance.

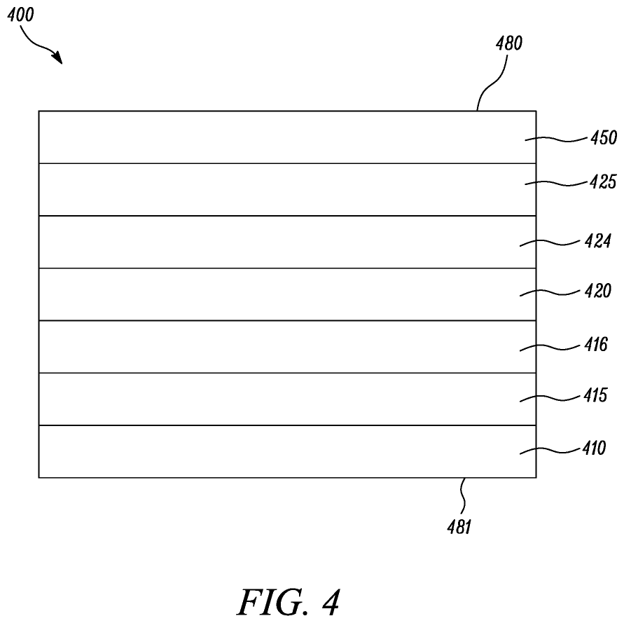

FIG. 4 shows a cross-sectional view of a fully coextruded shrink film 400, in accordance with an embodiment of the present disclosure. Shrink film 400 may be interchangeably referred to as “film 400”.

Film 400 includes a first polar polymer layer 410, a bonding layer 415, an internal layer 416, an internal layer 420, an internal layer 424, an internal layer 425, and a sealant layer 450. Film 400 is fully coextruded. In other words, first polar polymer layer 410, bonding layer 415, internal layer 416, internal layer 420, internal layer 424, internal layer 425, and sealant layer 450 are coextruded to each other. In some embodiments, film 400 is a coextruded blown film.

In some embodiments, film 400 is oriented. In some embodiments, film 400 may be oriented biaxially. In some embodiments, film 400 may be oriented along the machine direction. In some other embodiments, film 400 may be oriented along the transverse direction. Film 400 may be manufactured using existing co-extrusion equipment and technologies.

Sealant layer 450 is a first outer layer of film 400. In other words, sealant layer 450 may include a first major surface 480 of film 400. In some embodiments, first major surface 480 of film 400 may be exposed to a product (e.g., product 610 shown in FIG. 6), when film 400 is used in package 600 (shown in FIG. 6). In other words, sealant layer 450 may be exposed to the product, when film 400 is used in package 600 (shown in FIG. 6). In some embodiments, sealant layer 450 is substantially similar to sealant layer 150 (shown in FIG. 1).

In some embodiments, first polar polymer layer 410 is a second outer layer of film 400. In other words, first polar polymer layer 410 may include a second major surface 481 of film 400. In some embodiments, first polar polymer layer 410 may be exposed to the external environment, when film 400 is used in package 600 (shown in FIG. 6). In some embodiments, first polar polymer layer 410 including second major surface 481 of film 400 may provide an improved thermal resistance to film 400. Therefore, film 400 may not require polymer cross-linking techniques, such as EBC, in order to provide thermal resistance. This may improve the recyclability of film 400. Further, film 400 may not require any additional manufacturing processes. In some embodiments, first polar polymer layer 410 includes one or more of an EVOH copolymer, a polyamide, and a polyester.

Bonding layer 415 includes a blend of the bonding material and the compatibilizer material. In some embodiments, bonding layer 415 is positioned between first polar polymer layer 410 and sealant layer 450. In the illustrated embodiment of FIG. 4, bonding layer 415 is disposed directly adjacent to first polar polymer layer 410.

In some embodiments, internal layer 416 is positioned between first polar polymer layer 410 and sealant layer 450. In some embodiments, internal layer 416 includes one or more of an EVOH copolymer, a polyamide, and a polyester. In some embodiments, internal layer 416 may include a polyamide blend. In the illustrated embodiment of FIG. 4, internal layer 416 is disposed directly adjacent to bonding layer 415. In some embodiments, internal layer 416 may be substantially similar to bonding layer 415.

In some embodiments, internal layer 420 is positioned between first polar polymer layer 410 and sealant layer 450. Further, internal layer 420 is disposed directly adjacent to internal layer 416. In some embodiments, internal layer 420 includes one or more of an EVOH copolymer, a polyamide, and a polyester. In some embodiments, internal layer 420 may include a polyamide blend. In some embodiments, internal layer 420 may be substantially similar to bonding layer 415.

In some embodiments, internal layer 424 is positioned between first polar polymer layer 410 and sealant layer 450. Further, internal layer 424 is disposed directly adjacent to internal layer 420. In some embodiments, internal layer 424 includes one or more of an EVOH copolymer, a polyamide, and a polyester. In some embodiments, internal layer 424 may include a polyamide blend. In some embodiments, internal layer 424 may be substantially similar to bonding layer 415.

In some embodiments, internal layer 425 is positioned between first polar polymer layer 410 and sealant layer 450. Further, internal layer 425 is disposed directly adjacent to sealant layer 450. In some embodiments, internal layer 425 includes one or more of an EVOH copolymer, a polyamide, and a polyester. In some embodiments, internal layer 425 may include a polyamide blend. In some embodiments, internal layer 425 may be substantially similar to bonding layer 415.

In some embodiments, film 400 is recyclable. Thus, film 400 may not contaminate the recycling streams and provides a recyclate of quality that may not contaminate recycling streams. Specifically, the compatibilizer material in bonding layer 415 may allow film 400 to be recyclable in the recycling streams, for example, the polyethylene recycling stream. In other words, the compatibilizer material in bonding layers 415 may improve recyclability of film 400. In some embodiments, one or more of internal layers 420, 416, 424, 425 may further include the compatibilizer material to allow film 400 to be recyclable in the recycling streams.

Film 400 includes a shrinkage value of greater than 10% in each of the machine direction and the transverse direction when tested according to ASTM D2732-03 using a bath temperature of 90° C. In some embodiments, film 400 may include a shrinkage value greater than about 20%, greater than about 30%, greater than about 40%, or greater than about 50%, in each of the machine direction and the transverse direction when tested according to ASTM D2732-03 using the bath temperature of 90° C. Further, film 400 may have an improved interlayer bond strength and an improved puncture resistance.

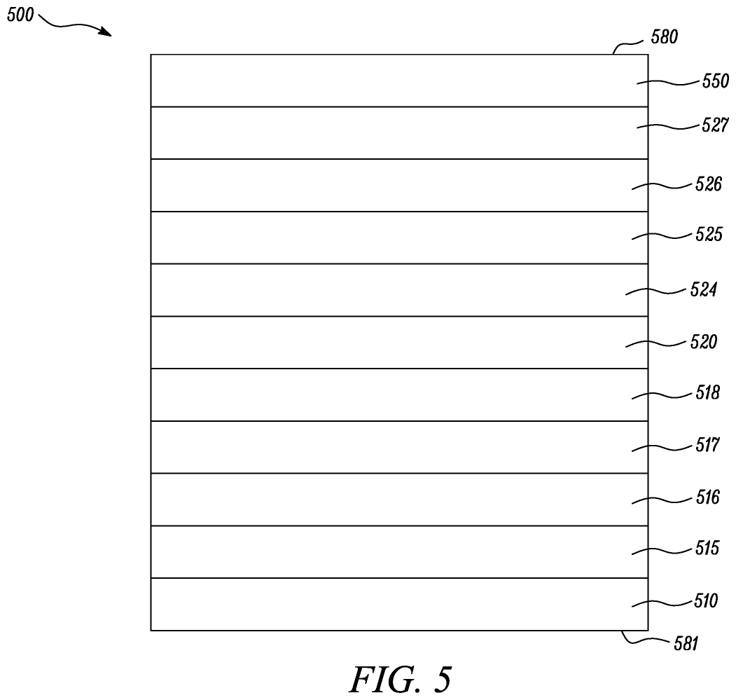

FIG. 5 shows a cross-sectional view of a fully coextruded shrink film 500, in accordance with an embodiment of the present disclosure. Shrink film 500 may be interchangeably referred to as “film 500”.

Film 500 includes a first polar polymer layer 510, a bonding layer 515, an internal layer 516, an internal layer 517, an internal layer 518, an internal layer 520, an internal layer 524, an internal layer 525, an internal layer 526, an internal layer 527, and a sealant layer 550. Film 500 is fully coextruded. In other words, first polar polymer layer 510, bonding layer 515, internal layer 516, internal layer 517, internal layer 518, internal layer 520, internal layer 524, internal layer 525, internal layer 526, internal layer 527, and sealant layer 550 are coextruded to each other. In some embodiments, film 500 is a coextruded blown film.

In some embodiments, film 500 is oriented. In some embodiments, film 500 may be oriented biaxially. In some embodiments, film 500 may be oriented along the machine direction. In some other embodiments, film 500 may be oriented along the transverse direction. Film 500 may be manufactured using existing co-extrusion equipment and technologies.

Sealant layer 550 is a first outer layer of film 500. In other words, sealant layer 550 may include a first major surface 580 of film 500. In some embodiments, first major surface 580 of film 500 may be exposed to a product (e.g., product 610 shown in FIG. 6), when film 500 is used in package 600 (shown in FIG. 6). In other words, sealant layer 550 may be exposed to the product, when film 500 is used in package 600 (shown in FIG. 6). In some embodiments, sealant layer 550 is substantially similar to sealant layer 150 (shown in FIG. 1).

In some embodiments, first polar polymer layer 510 is a second outer layer of film 500. In other words, first polar polymer layer 510 may include a second major surface 581 of film 500. In some embodiments, first polar polymer layer 510 may be exposed to the external environment, when film 500 is used in package 600 (shown in FIG. 6). In some embodiments, first polar polymer layer 510 including second major surface 581 of film 500 may provide an improved thermal resistance to film 500. Therefore, film 500 may not require polymer cross-linking techniques, such as EBC, in order to provide thermal resistance. This may improve the recyclability of film 500. Further, film 500 may not require any additional manufacturing processes. In some embodiments, first polar polymer layer 510 includes one or more of an EVOH copolymer, a polyamide, and a polyester.

Bonding layer 515 includes a blend of the bonding material and the compatibilizer material. In some embodiments, bonding layer 515 is positioned between first polar polymer layer 510 and sealant layer 550. In the illustrated embodiment of FIG. 5, bonding layer 515 is disposed directly adjacent to first polar polymer layer 510.

In some embodiments, internal layers 516, 517, 518, 520, 524, 525, 526, 527 are positioned between first polar polymer layer 510 and sealant layer 550. In some embodiments, one or more of internal layers 516, 517, 518, 520, 524, 525, 526, 527 may include one or more of an EVOH copolymer, a polyamide, and a polyester. In some embodiments, one or more of internal layers 516, 517, 518, 520, 524, 525, 526, 527 may include a polyamide blend. In some embodiments, one or more of internal layers 516, 517, 518, 520, 524, 525, 526, 527 may be substantially similar to bonding layer 515.

In some embodiments, film 500 is recyclable. Thus, film 500 may not contaminate the recycling streams and provide a recyclate of quality that may not contaminate recycling streams. Specifically, the compatibilizer material in bonding layer 515 may allow film 500 to be recyclable in the recycling streams, for example, the polyethylene recycling stream. In other words, the compatibilizer material in bonding layers 515 may improve recyclability of film 500. In some embodiments, one or more of internal layers 516, 517, 518, 520, 524, 525, 526, 527 may further include the compatibilizer material to allow film 500 to be recyclable in the recycling streams.

Film 500 includes a shrinkage value of greater than 10% in each of the machine direction and the transverse direction when tested according to ASTM D2732-03 using a bath temperature of 90° C. In some embodiments, film 500 may include a shrinkage value greater than about 20%, greater than about 30%, greater than about 40%, or greater than about 50%, in each of the machine direction and the transverse direction when tested according to ASTM D2732-03 using the bath temperature of 90° C. Further, film 500 may have an improved interlayer bond strength and an improved puncture resistance.

In some embodiments, film 100, 200, 300, 400, 500 may have a thickness from microns to 203 microns (1 mil to 8 mil).

FIG. 6 illustrates a perspective view of package 600 including shrink film 100, for product 610 disposed therein, in accordance with an embodiment of the present disclosure. However, in some other embodiments, package 600 may include shrink film 200, shrink film 300, shrink film 300, or shrink film 500 illustrated in FIGS. 2-5, respectively.

In the illustrated embodiment of FIG. 6, product 610 in package 600 is an edible product. In some embodiments, the edible product may include a solid, or a semi-solid product. In some other embodiments, product 610 may include, but is not limited to, meat and cheese. In other embodiments, the product may be a non-food item. Package 600 may take any number of forms including pouches, bags, sachets, or flow wrap.

Package 600 may include a single serving or may have multiple servings. In some embodiments, film 100 is required to be heat sealable.

By using film 100 in package 600, product 610 may be efficiently shrink wrapped for storage. Film 100 may have a shrinkage value of greater than 10% in both the machine direction and the transverse direction when measured according to ASTM D2732-03. Further, film 100 may be recyclable. Therefore, package 600 may be recyclable and may not contaminate the recycling streams. Film 100 may provide adequate thermal resistance and oxygen barrier properties. Accordingly, package 600 may provide adequate thermal resistance and oxygen barrier properties to product 610 from the external environment. Additionally, use of the blend of bonding material and compatibilizer material provides film 100 with improved mechanical properties, such as interlayer bond strength and puncture resistance.

### Examples and Data

The following examples are offered for illustrative purposes only and are not intended to limit the scope of the claims in any way. Indeed, various modifications of the disclosure in addition to those shown and described herein will become apparent to those skilled in the art from the foregoing description and the following examples and fall within the scope of the appended claims.

A sample shrink film was produced. Specifically, the sample shrink film was substantially similar to shrink film 300 illustrated in FIG. 3.

Table 1 below provides a composition and a weight of each layer of the sample shrink film. The weight of each layer is depicted as a percentage of weight of the sample shrink film. Table 1 further provides a comparison of the sample shrink film with a conventional shrink film. The materials used included a polyamide (PA) blend, an ethylene vinyl alcohol (EVOH) copolymer, and a polyethylene (PE) sealant.

TABLE 1
Compositions of Sample Shrink Film
and Conventional Shrink Film

| | Sample | Conventional |
|---|---|---|
| Layer | Shrink Film | Shrink Film |
| First Polar Polymer | 9.8% PA blend | 10.6% PA blend |
| Layer | | |
| First Bonding Layer | 27.5% blend of bonding | 26.7% tie blend |
| | material and | |
| | compatibilizer material | |
| Second Polar Polymer | 8% EVOH copolymer | 8% EVOH copolymer |
| Layer | | |
| Second Bonding | 41.1% blend of bonding | 41.1% tie blend |
| Layer | material and | |
| | compatibilizer material | |
| Sealant Layer | 13.6% PE sealant | 13.6% PE sealant |

Examples of compatibilizer material that can be used for the sample shrink film are Primacor™ or Retain™ 3000, from Dow Inc. Guidelines for quantity of the compatibilizer material to be used was from about 5% to about 35% by weight of polyamide in the first polar polymer layer and from about 5% to about 35% by weight of the EVOH copolymer in the second polar polymer layer. Typically, the compatibilizer material is not recommended to be included in a bonding layer (e.g., first bonding layer 315 or second bonding layer 325). However, upon including the compatibilizer material in the bonding layer, improved mechanical properties, such as an improved interlayer bond strength and an improved puncture resistance, were obtained.

Table 2 below provides properties of the sample shrink film as measured. Table 2 further provides values of the properties of the conventional shrink film to provide a basis for comparison of performance of the sample shrink film.

TABLE 2
Comparison of various Properties of Sample
Shrink Film and Conventional Shrink Film

| | Sample | Conventional |
|---|---|---|
| Property | Shrink Film | Shrink Film |
| 1) Puncture Resistance (kg) | 14.3 | 12 |
| 2) Shrink % (85° C.) MD × TD | 34 × 38 | 38 × 38 |
| 3) Shrink % (90° C.) MD × TD | 43 × 43 | 43 × 43 |
| 4) Shrink % (95° C.) MD × TD | 52 × 51 | 51 × 51 |
| 5) Haze % | 4.1 | 9.3 |
| 6) 45-degree Gloss % | 83.2 | 73.7 |
| 7) Tensile strength at break, MD | 75.69 | 65.19 |
| (MPa) | | |
| 8) Tensile strength at break, TD | 66.28 | 56.84 |
| (MPa) | | |
| 9) Secant Modulus, MD (MPa) | 475.95 | 371.7 |
| 10) Secant Modulus, TD (MPa) | 506.69 | 346.34 |
| 11) Elongation %, MD | 97 | 129 |
| 12) Elongation %, TD | 116 | 137 |
| 13) Bond Strength, Interlayer | 11.69/8.42 | 3.42/2.12 |
| Peak/Avg (g/mm) | | |
| 14) Oxygen Transmission Rate | 13.1 | 15.8 |
| (cc/m²/day) | | |
| 15) Moisture Vapor Transmission | 9.15 | 9.77 |
| Rate (g/m²/day) | | |
| Thickness for properties 1)-13) | 47 | 74 |
| (microns) | | |
| Thickness for properties 14)-15) | 47 | 48 |
| (microns) | | |

Haze was measured according to ASTM D1003-07. Tensile strength was measured according to ASTM D882-12, with MD at a 40.64 cm (4 inch) span and 5.08 cm (2 inch) per minute crosshead speed and TD at a 5.08 (2 inch) span and 50.8 cm (20 inch) per minute crosshead speed. Secant Modulus was also measured according to ASTM D882-12. Oxygen Transmission Rate was measured according to ASTM F1927-07 at 23° C. (73 degrees Fahrenheit (° F.)) and 85% relative humidity. Moisture Vapor Transmission Rate was measured according to ASTM F1249-06 at 38° C. (100° F.) and 90% relative humidity.

It may be observed from Table 2 that a shrinkage value of the sample shrink film was substantially similar to a shrinkage value of the conventional shrink film. Further, oxygen and moisture vapor barrier properties of the sample shrink film were also substantially similar to oxygen and moisture vapor barrier properties of the conventional shrink film. However, a puncture resistance of sample shrink film was about 20% greater than a puncture resistance of the conventional shrink film. Further, an average interlayer bond strength of sample shrink film was substantially greater than an average interlayer bond strength of the conventional shrink film. Specifically, the average interlayer bond strength of sample shrink film was greater than about 4 times the average interlayer bond strength of the conventional shrink film. In addition, the sample shrink film was recyclable.

### EMBODIMENTS

A. A fully coextruded, shrink film comprising:
   a first polar polymer layer;
   a bonding layer; and
   a sealant layer;
wherein the bonding layer comprises a blend of a bonding material and a compatibilizer material, wherein the sealant layer is a first outer layer of the film, wherein the bonding layer comprising the compatibilizer material is positioned between the first polar polymer layer and the sealant layer, and wherein the film includes a Shrinkage Value of greater than 10% in each of the machine direction and the transverse direction when tested according to ASTM D2732-03 using a bath temperature of 90 degrees Celsius (° C.).
B. A fully coextruded, shrink film comprising:
   a first polar polymer layer comprising a polyamide;
   a first bonding layer comprising a compatibilizer material and a bonding material;
   a second polar polymer layer comprising an ethylene vinyl alcohol (EVOH) copolymer;
   a second bonding layer comprising the compatibilizer material and the bonding material; and
   a sealant layer;
wherein the sealant layer is a first outer layer of the film, wherein the first polar polymer layer is a second outer layer of the film, wherein the first bonding layer is positioned between the first polar polymer layer and the second polar polymer layer, wherein the second bonding layer is positioned between the second polar polymer layer and the sealant layer, and wherein the film includes a Shrinkage Value of greater than 10% in each of the machine direction and the transverse direction when tested according to ASTM D2732-03 using a bath temperature of 90 degrees Celsius (° C.).
C. A fully coextruded, shrink film according to any other Embodiment wherein the first polar polymer layer comprises one or more of an ethylene vinyl alcohol copolymer, a polyamide, and a polyester.
D. A fully coextruded, shrink film according to any other Embodiment wherein the first polar polymer layer is a second outer layer of the film.
E. A fully coextruded, shrink film according to Embodiments A, C or D, further comprising a second polar polymer layer positioned between the first polar polymer layer and the sealant layer.
F. A fully coextruded, shrink film according to Embodiments A, C, D, or E wherein the bonding layer comprises the compatibilizer material in an amount from 5% to 35% by weight of the first polar polymer layer.
G. A fully coextruded, shrink film according to any Embodiments C, D, or E wherein the bonding layer comprises the compatibilizer material in an amount from 5% to 35% by weight of the second polar polymer layer.
H. A fully coextruded, shrink film according to any other Embodiment, further comprising an intermediate layer comprising the compatibilizer material.
I. A fully coextruded, shrink film according to any other Embodiment, wherein the compatibilizer material comprises one or more of a low molecular weight anhydride and a carboxylic acid functionalized polyethylene.
J. A fully coextruded, shrink film according to any other Embodiment, wherein the bonding material comprises a polyethylene polymer, an ethylene acrylic acid (EAA) copolymer, a two-component reactive adhesive, or combinations thereof.
K. A fully coextruded, shrink film according to any other Embodiment, wherein the film is recyclable.
L. A fully coextruded, shrink film according to any other Embodiment, comprising an average interlayer bond strength of greater than about 8 grams per millimeter (g/mm).
M. A package comprising the fully coextruded, shrink film according to any other Embodiment.
N. A fully coextruded, shrink film according to Embodiment B, wherein the first bonding layer comprises the compatibilizer material in an amount from 5% to 35% by weight of the polyamide in the first polar polymer layer.
O. A fully coextruded, shrink film according to Embodiments B or E-N wherein the second bonding layer comprises the compatibilizer material in an amount from 5% to 35% by weight of the ethylene vinyl alcohol (EVOH) copolymer in the second polar polymer layer.

Each and every document cited in this present application, including any cross referenced, is incorporated in this present application in its entirety by this reference, unless expressly excluded or otherwise limited. The citation of any document is not an admission that it is prior art with respect to any embodiment disclosed in this present application or that it alone, or in any combination with any other reference or references, teaches, suggests, or discloses any such embodiment. Further, to the extent that any meaning or definition of a term in this present application conflicts with any meaning or definition of the same term in a document incorporated by reference, the meaning or definition assigned to that term in this present application governs.

The description, examples, embodiments, and drawings disclosed are illustrative only and should not be interpreted as limiting. The present invention includes the description, examples, embodiments, and drawings disclosed; but it is not limited to such description, examples, embodiments, or drawings. As briefly described above, the reader should assume that features of one disclosed embodiment can also be applied to all other disclosed embodiments, unless expressly indicated to the contrary. Modifications and other embodiments will be apparent to a person of ordinary skill in the packaging arts, and all such modifications and other embodiments are intended and deemed to be within the scope of the present invention.

1. A fully coextruded, shrink film comprising:
a first polar polymer layer;
a bonding layer; and
a sealant layer;
wherein the bonding layer comprises a blend of a bonding material and a compatibilizer material, wherein the sealant layer is a first outer layer of the film, wherein the bonding layer comprising the compatibilizer material is positioned between the first polar polymer layer and the sealant layer, and wherein the film includes a Shrinkage Value of greater than 10% in each of the machine direction and the transverse direction when tested according to ASTM D2732-03 using a bath temperature of 90 degrees Celsius (° C.).

2. The film of claim 1, wherein the first polar polymer layer comprises one or more of an ethylene vinyl alcohol copolymer, a polyamide, and a polyester.

3. The film of claim 1, wherein the first polar polymer layer is a second outer layer of the film.

4. The film of claim 1, further comprising a second polar polymer layer positioned between the first polar polymer layer and the sealant layer.

5. The film of claim 1, wherein the bonding layer comprises the compatibilizer material in an amount from 5% to 35% by weight of the first polar polymer layer.

6. The film of claim 4, wherein the bonding layer comprises the compatibilizer material in an amount from 5% to 35% by weight of the second polar polymer layer.

7. The film of claim 1, further comprising an intermediate layer comprising the compatibilizer material.

8. The film of claim 1, wherein the compatibilizer material comprises one or more of a low molecular weight anhydride and a carboxylic acid functionalized polyethylene.

9. The film of claim 1, wherein the bonding material comprises a polyethylene polymer, an ethylene acrylic acid (EAA) copolymer, a two-component reactive adhesive, or combinations thereof.

10. The film of claim 1, wherein the film is recyclable.

11. The film of claim 1, comprising an average interlayer bond strength of greater than about 8 grams per millimeter (g/mm).

12. A package comprising the film of claim 1.

13. A fully coextruded, shrink film comprising:
a first polar polymer layer comprising a polyamide;
a first bonding layer comprising a compatibilizer material and a bonding material;
a second polar polymer layer comprising an ethylene vinyl alcohol (EVOH) copolymer;
a second bonding layer comprising the compatibilizer material and the bonding material; and
a sealant layer;
wherein the sealant layer is a first outer layer of the film, wherein the first polar polymer layer is a second outer layer of the film, wherein the first bonding layer is positioned between the first polar polymer layer and the second polar polymer layer, wherein the second bonding layer is positioned between the second polar polymer layer and the sealant layer, and wherein the film includes a Shrinkage Value of greater than 10% in each of the machine direction and the transverse direction when tested according to ASTM D2732-03 using a bath temperature of 90 degrees Celsius (° C.).

14. The film of claim 13, wherein the first bonding layer comprises the compatibilizer material in an amount from 5% to 35% by weight of the polyamide in the first polar polymer layer.

15. The film of claim 13, wherein the second bonding layer comprises the compatibilizer material in an amount from 5% to 35% by weight of the ethylene vinyl alcohol (EVOH) copolymer in the second polar polymer layer.

16. A package comprising the film of claim 13.
